(19) United States
(12) Patent Application Publication
(10) Pub. No.: US 2019/0015977 A1
(43) Pub. Date: Jan. 17, 2019

(54) ROBOT

(71) Applicant: HON HAI PRECISION INDUSTRY CO., LTD., New Taipei (TW)

(72) Inventor: CHIA-WEN CHANG, New Taipei (TW)

(21) Appl. No.: 15/713,810

(22) Filed: Sep. 25, 2017

(30) Foreign Application Priority Data
Jul. 13, 2017 (TW) 106123544

(51) Int. Cl. B25J 9/16; B25J 13/08; B25J 13/00

(52) U.S. Cl. CPC B25J 9/163; B25J 13/006; B25J 13/089

(57) ABSTRACT

A robot includes a robot body and an operating system. The operating system includes a positioning module and an action performance module. The positioning module positions the robot and judges whether the position is in a target area. The action performance module is a behavior tree. A judged result from the positioning module triggers the behavior tree, so that the robot performs corresponding action.

### CROSS-REFERENCE TO RELATED APPLICATIONS

This application claims all benefits accruing under 35 U.S.C. § 119 from Taiwan Patent Application No. 106123544, filed on Jul. 13, 2017, in the Taiwan Intellectual Property Office. Disclosures of the above-identified applications are incorporated herein by reference.

### FIELD

The present application relates to a robot.

### BACKGROUND

A robot is a machine, especially one programmable by a computer, capable of carrying out a complex series of actions automatically. Robots can be guided by an external control device or the control may be embedded within the robot. Robots may be constructed to look human but most robots are machines designed perform a task without regard to how they look.

Artificial intelligence behavior is closely related to the robot. In order to facilitate the realization of artificial intelligence behavior, behavioral tree editors are prepared. The behavioral tree editors provide nodes such as sequential nodes, conditional nodes, and execution nodes for building behavior trees. However, there is no behavior tree that is constructed by location nodes, and no behavior tree with the location node is applied to the robot.

What is needed, therefore, is to provide a robot that can overcome the above-described shortcomings.

### BRIEF DESCRIPTION OF THE DRAWINGS

Implementations of the present technology will now be described, by way of example only, with reference to the attached figures, wherein:

FIG. 1 is a schematic view of a first embodiment of a robot.

FIG. 2 is a functional diagram of the first embodiment of an operating system.

FIG. 3 is a schematic view of the first embodiment of a behavior tree.

FIG. 4 is another schematic view of the first embodiment of the behavior tree.

FIG. 5 is a flow chart of a working method of the operating system in FIG. 2.

FIG. 6 is a flow chart of a working method of the operating system of FIG. 2 in situation I.

FIG. 7 is a flow chart of a working method of the operating system of FIG. 2 in situation II.

FIG. 8 is a schematic view of a second embodiment of a robot.

FIG. 9 is a functional diagram of the second embodiment of an operating system.

FIG. 10 is a schematic view of the second embodiment of a behavior tree.

FIG. 11 is another schematic view of the second embodiment of the behavior tree.

FIG. 12 is a flow chart of a working method of the operating system in FIG. 9.

FIG. 13 is a flow chart of a working method of the operating system of FIG. 9 in situation III.

FIG. 14 is a flow chart of another working method of the operating system in FIG. 9.

FIG. 15 is a flow chart of a working method of the operating system of FIG. 9 in situation IV.

FIG. 16 is a flow chart of a working method of the operating system of FIG. 9 in situation V.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated to illustrate details and features better. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

In general, the word “module” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

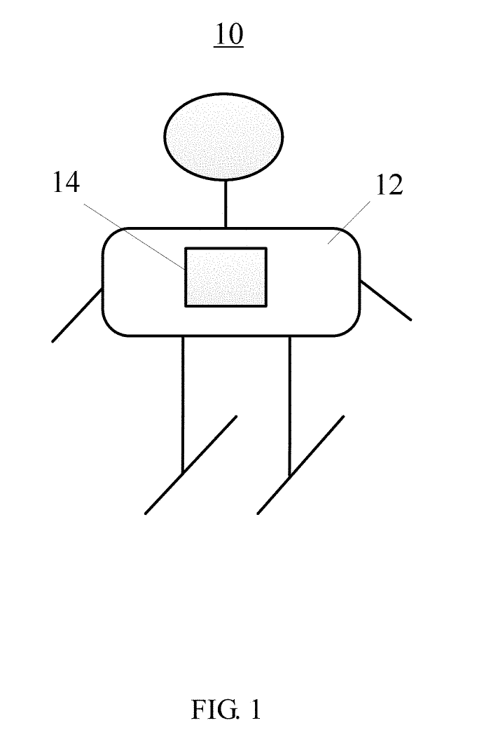

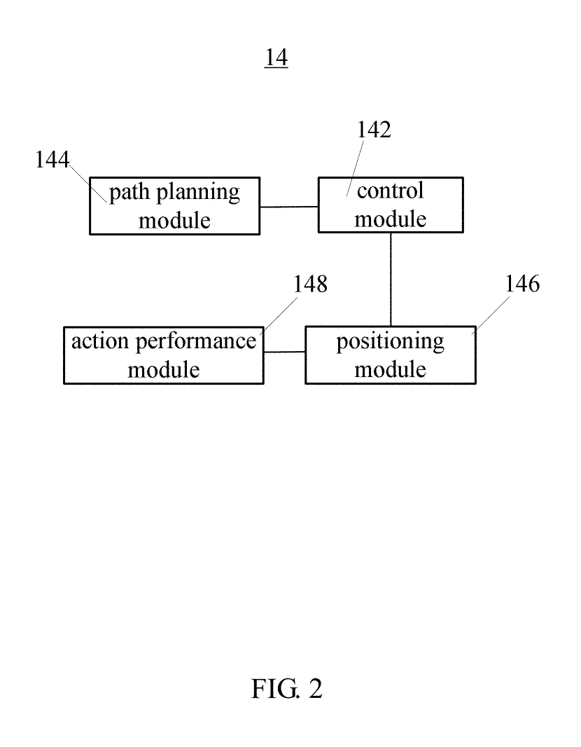

Referring to FIGS. 1 and 2, a robot 10 of a first embodiment is shown. The robot 10 includes a robot body 12 and an operating system 14 being in or on the robot body 12. The operating system 14 controls the robot body 12. The robot body 12 includes a body of the robot 10 and a hardware device located on or in the body of the robot 10. The hardware device includes a laser radar sensor (LiDAR), a distance measuring camera (RGB-D camera), a GPS device, or any combination thereof. The operating system 14 is software. The operating system 14 includes a control module 142, a path planning module 144, a positioning module 146, and an action performance module 148.

The path planning module 144 is used to plan the path of movement of the robot 10 according to the data of the initial position of the robot 10 and the data of the target area, so that the planned path data is formed. The planned path data is sent to the control module 142 by the path planning module 144. The data of the initial position of the robot 10 and the data of the target area can be manually inputted or can be received from other devices. The initial position of the robot 10 can be automatically determined by the positioning module 146, such as GPS.

The control module 142 receives the planned path data and control the robot 10 to move along the planned path.

The positioning module 146 positions the robot 10, judges whether the position is in a particular area, and transmit the judged result to the action performance module 148. The positioning module 146 can position the robot 10 by emitting laser or radar.

The action performance module 148 is a behavior tree. The behavior tree includes at least one child node. The behavior tree can include a first parent node and at least one child node. The first parent node judges whether a condition is satisfied. The child node is for performing an action, i.e., cause the robot 10 to dance. When the action performance module 148 includes the first parent node, the judged result of the positioning module 146 triggers the first parent node, the child node would be triggered by the first parent mode, and the robot 10 makes certain action according to the child nodes. When the action performance module 148 includes only child nodes, the judged result of the positioning module 146 directly triggers the child nodes, and the robot 10 makes certain action according to the child nodes. Thus, when the judged result is transmitted to the action performance module 148 by the positioning module 146, the behavior tree is executed.

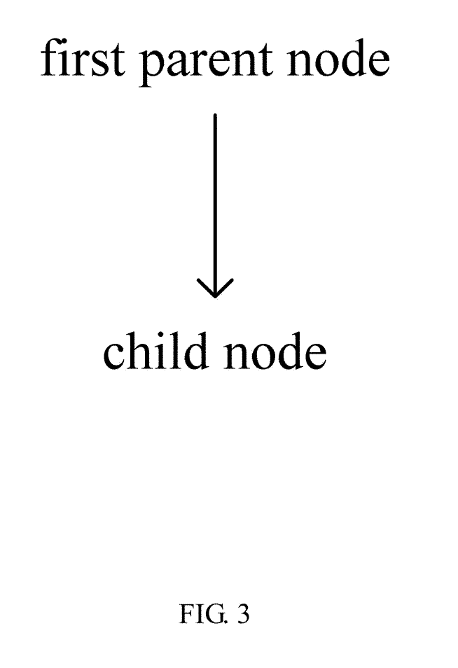

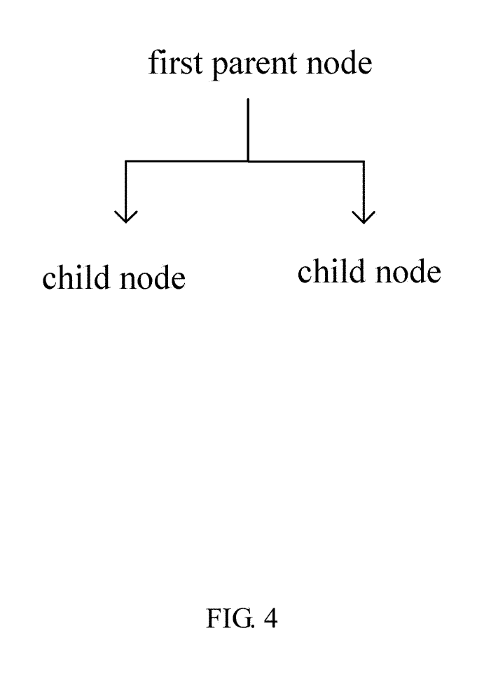

The child nodes can be parallel relation, sequential relation, or selective relation. The “parallel relation” means that the child nodes are executed at the same time. The “sequential relation” means that the child nodes are executed in succession. The “selective relation” means that only some child nodes are executed according to the instructions of the first parent node. In one embodiment, the behavior tree includes only one child node. In another embodiment, the behavior tree includes more than one parallel child nodes. FIG. 3 shows the behavior tree including one first parent node and one child node. FIG. 4 shows the behavior tree including one first parent node and more than one parallel child nodes.

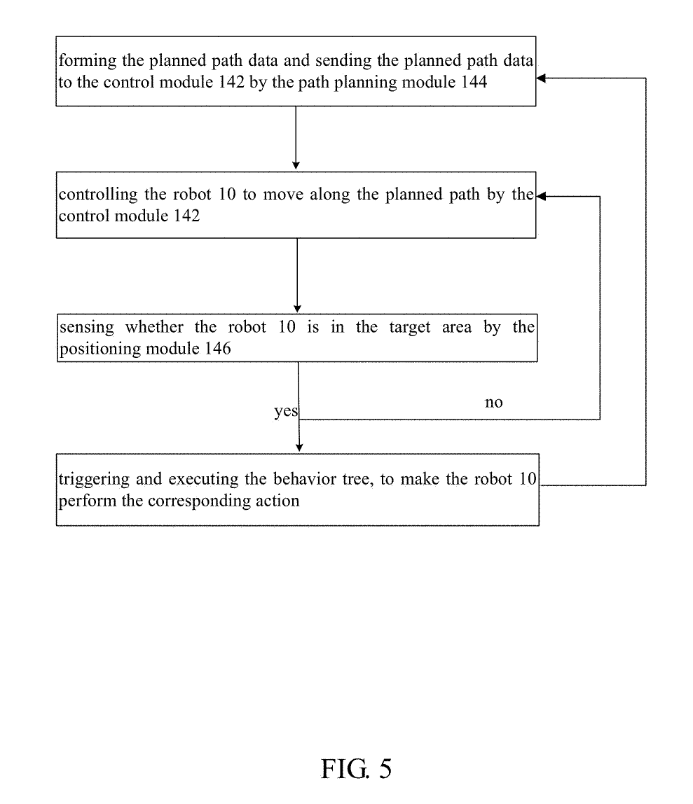

Referring to FIG. 5, a working method of the operating system 14 of the first embodiment includes following steps:

S10, forming the planned path data and sending the planned path data to the control module 142 by the path planning module 144;

S11, controlling the robot 10 to move along the planned path by the control module 142;

S12, sensing whether the robot 10 is in the target area by the positioning module 146, if yes, go to S13, if no, back to S11; and

S13, triggering and executing the behavior tree, to make the robot 10 perform the corresponding action, and back to S10.

Hereinafter, in the first embodiment, the working methods of the operating system 14 in different situations are described.

Situation I: the robot 10 is a narrator at an exhibition area A of an exhibition hall. In the situation I, the behavior tree includes one first parent node and one child node. The first parent node judges whether there is anyone in the exhibition area A. If there is a person in the exhibition area A, the child node is triggered; if no one is in exhibition area A, the child node is not triggered. The child node makes the robot 10 speak.

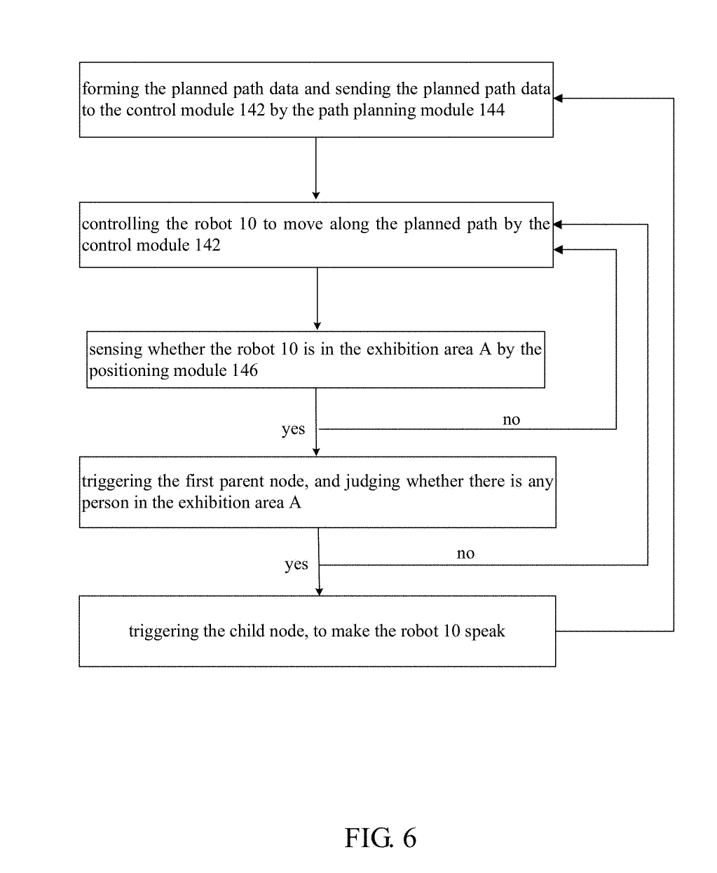

Referring to FIG. 6, a working method of the operating system 14 in the situation I includes following steps:

S10′, forming the planned path data and sending the planned path data to the control module 142 by the path planning module 144;

S11′, controlling the robot 10 to move along the planned path by the control module 142;

S12′, sensing whether the robot 10 is in the exhibition area A by the positioning module 146, if yes, go to S13′, if no, back to S11′;

S13′, triggering the first parent node, and judging whether there is any person in the exhibition area A, if yes, go to S14′, if no, back to S11′; and

S14′, triggering the child node, to make the robot 10 speak, and back to S10′.

Situation II: the robot 10 is a deliverer and delivers food to room 2 on the third floor of a building. In the situation II, the behavior tree includes one first parent node, two parallel first child nodes, and two parallel second child nodes. The first child nodes and the second child nodes are selective relation. The first parent node judges whether a door is open. If the door is open, the first child node is triggered so that the robot 10 lays down the food and says “here is your food”. If the door is not open, the second child nodes are triggered, so that the robot 10 knocks on the door and says “is there anyone in the room”.

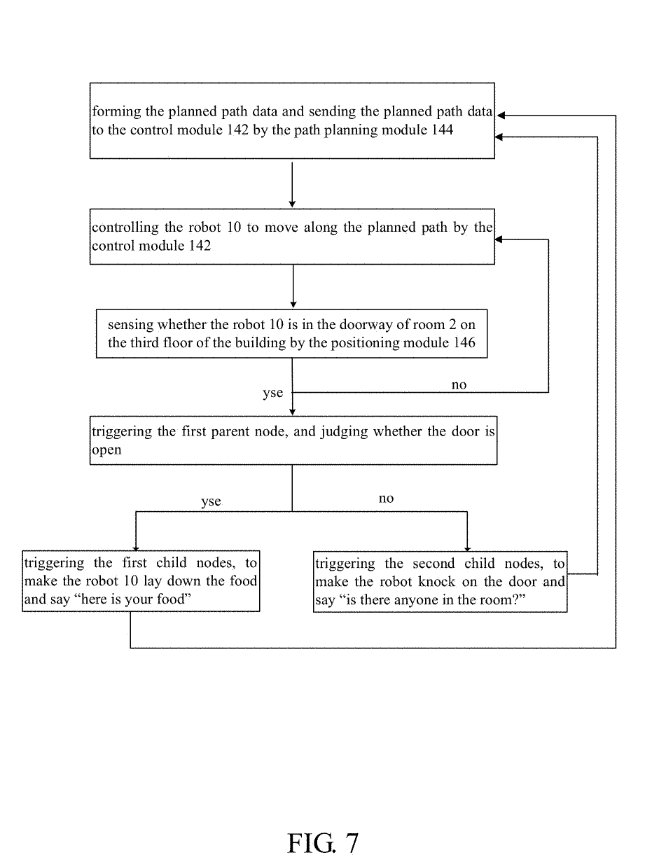

Referring to FIG. 7, a working method of the operating system 14 in the situation II includes following steps:

S10″, forming the planned path data and sending the planned path data to the control module 142 by the path planning module 144;

S11″, controlling the robot 10 to move along the planned path by the control module 142;

S12″, sensing whether the robot 10 is in the doorway of room 2 on the third floor of the building by the positioning module 146, if yes, go to S13″, if no, back to S11″;

S13″, triggering the first parent node, and judging whether the door is open, if yes, go to S14″, if no, go to S15″;

S14″, triggering the first child nodes, to make the robot 10 lay down the food and say “here is your food”, and back to S10″; and

S15″, triggering the second child nodes, to make the robot knock on the door and say “is there anyone in the room?”.

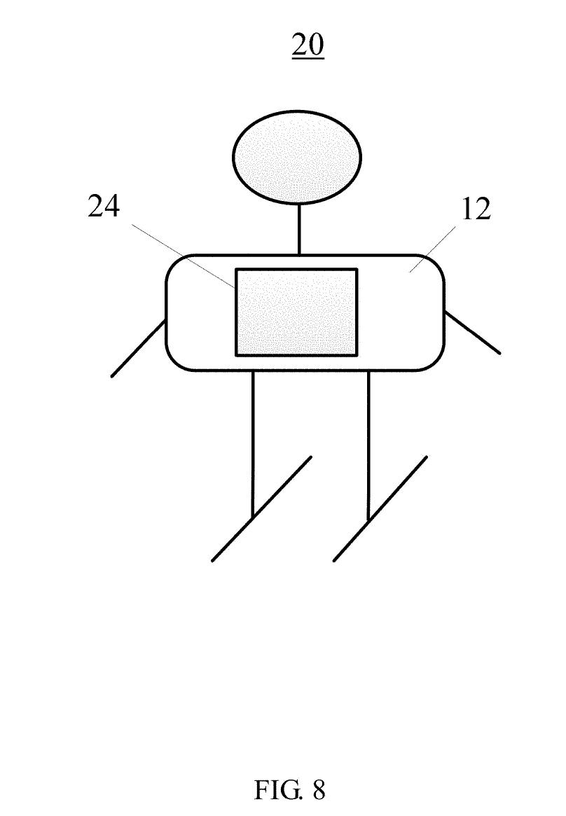

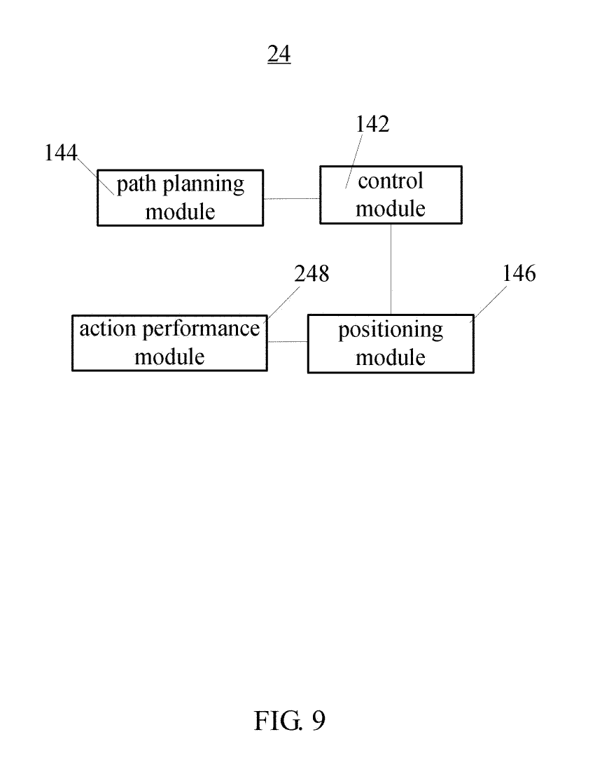

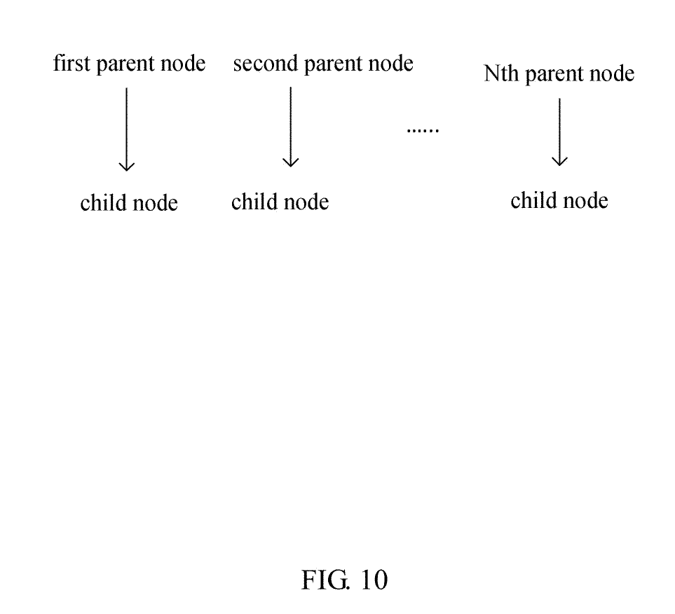

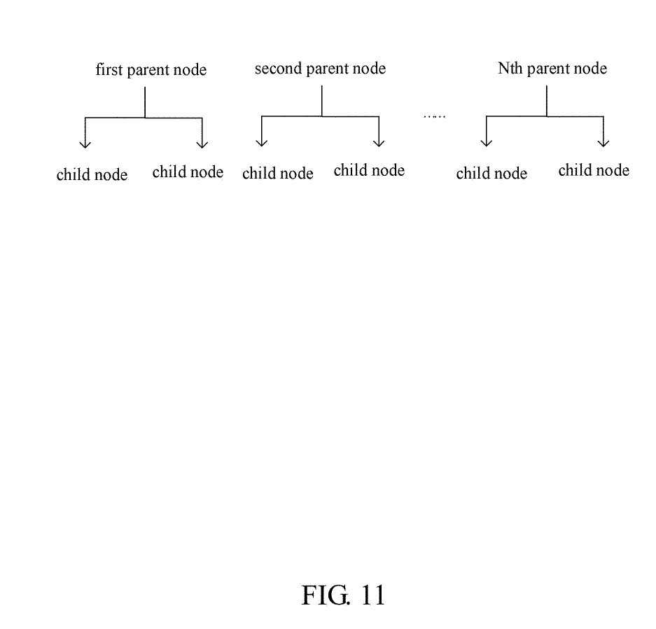

Referring to FIGS. 8 and 9, a robot 20 of a second embodiment is shown. The robot 20 includes the robot body 12 and the operating system 24. The operating system 24 includes the control module 142, the path planning module 144, the positioning module 146, and an action performance module 248. The robot 20 in the second embodiment is similar to the robot 10 in the first embodiment above except the action performance modules, which have different behavior trees in the first and second embodiments. In the first embodiment, the planned path data includes data of only one target area, the action performance module 148 includes only one behavior tree which includes only one first parent node, and the data of the target area only triggers the first parent node. In the second embodiment, the planned path data includes data of a plurality of target areas, and the action performance module 248 includes a plurality of behavior trees. The plurality of target areas is sequentially defined as a first area, a second area . . . a Nth area. The plurality of behavior trees is sequentially defined as a first behavior tree, a second behavior tree . . . a Nth behavior tree. Each area corresponds to one behavior tree, and the N behavior trees correspond to the N areas one by one. The data of each area can trigger the corresponding behavior tree. The first behavior tree includes one first parent node and one or more child nodes. The second behavior tree includes one second parent node and one or more child nodes. And so on, the Nth behavior tree includes one Nth parent node and one or more child nodes. The N is an integer, and N≥2. FIG. 10 shows a behavior tree including the plurality of parent nodes, and each parent nodes includes one child node. FIG. 11 shows a behavior tree including the plurality of parent nodes, and each parent nodes includes two parallel child nodes.

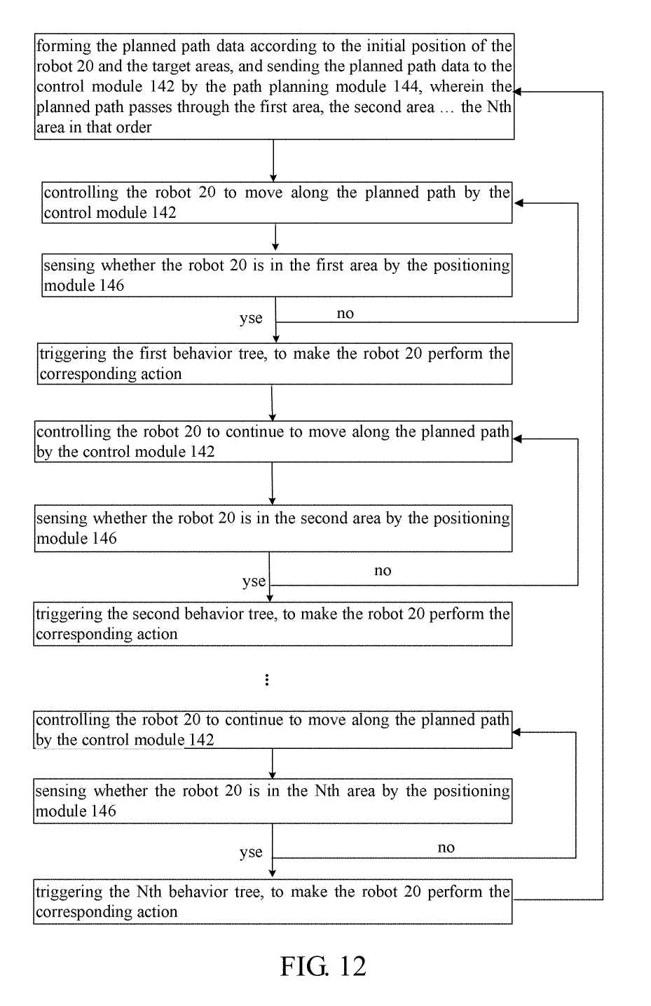

Referring to FIG. 12, a working method of the operating system 24 of the second embodiment includes following steps:

S20, forming the planned path data according to the initial position of the robot 20 and the target areas, and sending the planned path data to the control module 142 by the path planning module 144, wherein the planned path passes through the first area, the second area . . . the Nth area in that order;

S21, controlling the robot 20 to move along the planned path by the control module 142;

S22, sensing whether the robot 20 is in the first area by the positioning module 146, if yes, go to S23, if no, back to S21;

S23, triggering the first behavior tree, to make the robot 20 perform the corresponding action, and go to S24;

S24, controlling the robot 20 to continue to move along the planned path by the control module 142;

S25, sensing whether the robot 20 is in the second area by the positioning module 146, if yes, go to S26, if no, back to S24;

S26, triggering the second behavior tree, to make the robot 20 perform the corresponding action, and go to next step;

. . .

S27, controlling the robot 20 to continue to move along the planned path by the control module 142;

S28, sensing whether the robot 20 is in the Nth area by the positioning module 146, if yes, go to S29, if no, back to S27; and

S29, triggering the Nth behavior tree, to make the robot 20 perform the corresponding action, and back to S20.

Hereinafter, in the second embodiment, the working method of the operating system 24 in situation III is described.

Situation III: the robot 20 is a narrator at an exhibition hall which includes an exhibition area A, an exhibition area B, and an exhibition area C.

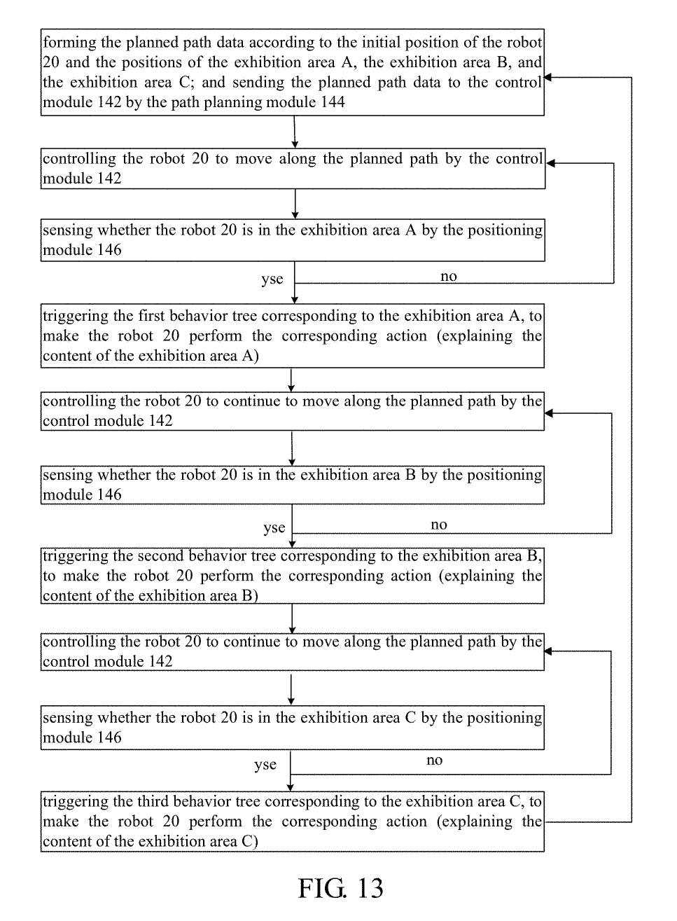

Referring to FIG. 13, a working method of the operating system 24 of the situation III includes following steps:

S20′, forming the planned path data according to the initial position of the robot 20 and the positions of the exhibition area A, the exhibition area B, and the exhibition area C; and sending the planned path data to the control module 142 by the path planning module 144;

S21′, controlling the robot 20 to move along the planned path by the control module 142;

S22′, sensing whether the robot 20 is in the exhibition area A by the positioning module 146, if yes, go to S23′, if no, back to S21′;

S23′, triggering the first behavior tree corresponding to the exhibition area A, to make the robot 20 perform the corresponding action (explaining the content of the exhibition area A), and go to S24′;

S24′, controlling the robot 20 to continue to move along the planned path by the control module 142;

S25′, sensing whether the robot 20 is in the exhibition area B by the positioning module 146, if yes, go to S26′, if no, back to S24′;

S26′, triggering the second behavior tree corresponding to the exhibition area B, to make the robot 20 perform the corresponding action (explaining the content of the exhibition area B), and go to S27′;

S27′, controlling the robot 20 to continue to move along the planned path by the control module 142;

S28′, sensing whether the robot 20 is in the exhibition area C by the positioning module 146, if yes, go to S29′, if no, back to S27′; and

S29′, triggering the third behavior tree corresponding to the exhibition area C, to make the robot 20 perform the corresponding action (explaining the content of the exhibition area C), and back to S20′.

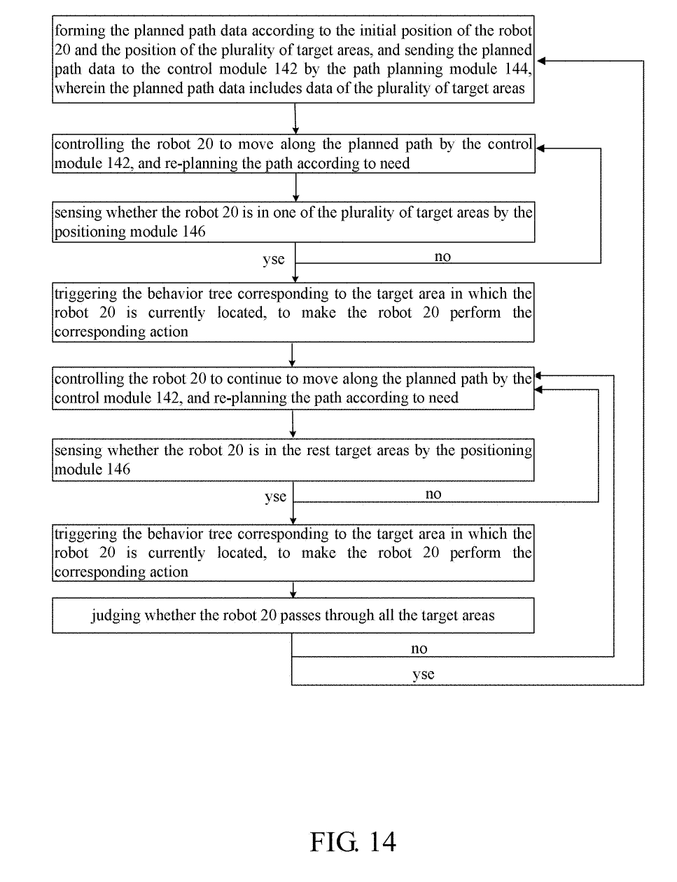

Referring to FIG. 14, another working method of the operating system 24 of the second embodiment includes following steps:

S30, forming the planned path data according to the initial position of the robot 20 and the position of the plurality of target areas, and sending the planned path data to the control module 142 by the path planning module 144, wherein the planned path data includes data of the plurality of target areas;

S31, controlling the robot 20 to move along the planned path by the control module 142, and re-planning the path according to need;

S32, sensing whether the robot 20 is in one of the plurality of target areas by the positioning module 146, if yes, go to S33, if no, back to S31;

S33, triggering the behavior tree corresponding to the target area in which the robot 20 is currently located, to make the robot 20 perform the corresponding action, and go to S34;

S34, controlling the robot 20 to continue to move along the planned path by the control module 142, and re-planning the path according to need;

S35, sensing whether the robot 20 is in the rest target areas by the positioning module 146, if yes, go to S36, if no, back to S34;

S36, triggering the behavior tree corresponding to the target area in which the robot 20 is currently located, to make the robot 20 perform the corresponding action, and go to S37; and

S37, judging whether the robot 20 passes through all the target areas, if yes, back to S30, if no, back to S34.

Hereinafter, in the second embodiment, the working methods of the operating system 24 in some situations are described.

Situation IV: the robot 20 is a patrolman in a park. Assuming there are five iron chairs in the park. When the iron plate of the chair is tilted, the iron plate needs to be struck with a small hammer by the robot 20. In the situation IV, the parent node judges whether the iron plate of the chair is tilted. If the iron plate is tilted, the child node is triggered, so that the robot 20 strikes the iron plate. If the iron plate is not tilted, the child node is not triggered.

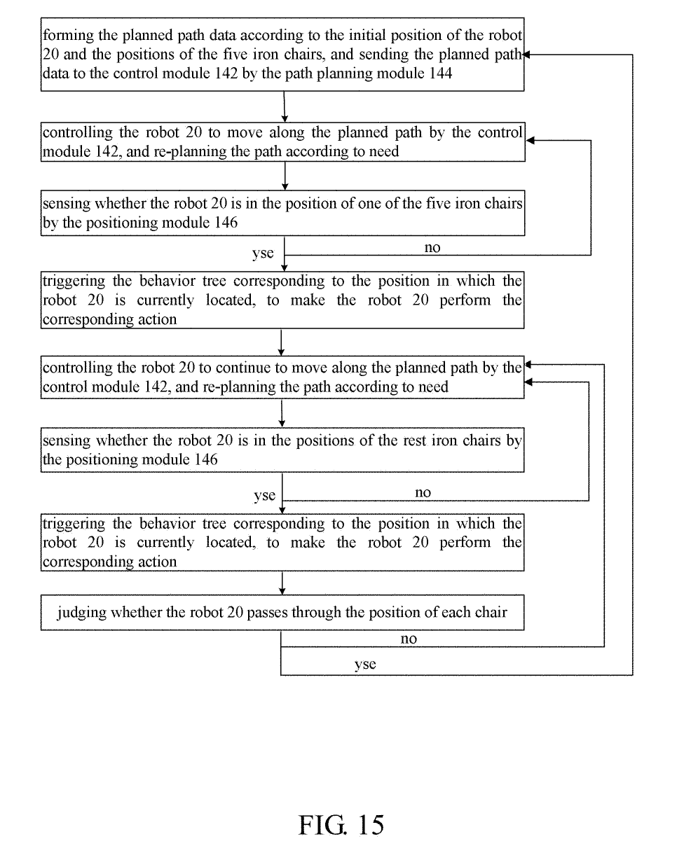

Referring to FIG. 15, a working method of the operating system 24 in the situation IV includes following steps:

S30′, forming the planned path data according to the initial position of the robot 20 and the positions of the five iron chairs, and sending the planned path data to the control module 142 by the path planning module 144;

S31′, controlling the robot 20 to move along the planned path by the control module 142, and re-planning the path according to need;

S32′, sensing whether the robot 20 is in the position of one of the five iron chairs by the positioning module 146, if yes, go to S33′, if no, back to S31′;

S33′, triggering the behavior tree corresponding to the position in which the robot 20 is currently located, to make the robot 20 perform the corresponding action, and go to S34′;

S34′, controlling the robot 20 to continue to move along the planned path by the control module 142, and re-planning the path according to need;

S35′, sensing whether the robot 20 is in the positions of the rest iron chairs by the positioning module 146, if yes, go to S36′, if no, back to S34′;

S36′, triggering the behavior tree corresponding to the position in which the robot 20 is currently located, to make the robot 20 perform the corresponding action, and go to S37′; and

S37′, judging whether the robot 20 passes through the position of each chair, if yes, back to S30′, if no, back to S34′.

Situation V: the robot 20 is a patrolman in a park. There are five monitoring areas in the park. In the situation V, the parent node judges whether there is anyone in the five monitoring areas. If the parent node judges there is a person in the five monitoring areas, the child node is triggered. The robot 20 takes a picture and sends a notification to the control center. If the parent node judges there is no person in the five monitoring areas, the child node is not triggered. The five monitoring areas can correspond to the same or different behavior tree.

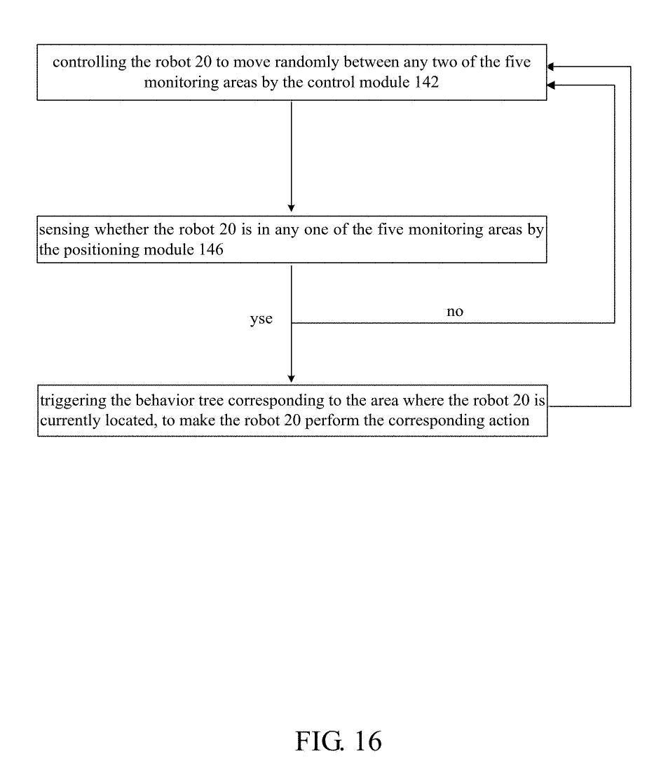

Referring to FIG. 16, a working method of the operating system 24 in the situation V includes following steps:

S30″, controlling the robot 20 to move randomly between any two of the five monitoring areas by the control module 142;

S31″, sensing whether the robot 20 is in any one of the five monitoring areas by the positioning module 146, if yes, go to S32″, if no, back to S30″; and

S32″, triggering the behavior tree corresponding to the area where the robot 20 is currently located, to make the robot 20 perform the corresponding action, and back to S30″.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves such as data transmission through the internet. The computer readable recording medium can also be distributed over network coupled computer systems so that the computer readable code is stored and executed in a distributed fashion.

The blocks illustrated above do not necessarily imply that there is required or preferred order for the blocks and the order and arrangement of the block may be varied. Furthermore, it may be possible for some blocks to be omitted.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Additionally, it is also to be understood that the above description and the claims drawn to a method may include some indication in reference to certain steps. However, the indication used is only to be viewed for identification purposes and not as a suggestion as to an order for the steps.

What is claimed is:

1. A robot comprising:
a robot body; and
an operating system comprising a positioning module and an action performance module; wherein the positioning module is used to position the robot and judge whether a position of the robot is in a target area; and the action performance module is a behavior tree, and a judged result of the positioning module is used to trigger the behavior tree.

2. The robot of claim 1, wherein the action performance module comprises at least one parent node and at least one child node; and the at least one parent node is used to judge whether a condition is satisfied, and if so, the at least one child node is used to make the robot perform an action.

3. The robot of claim 1, wherein the action performance module comprises at least one child node, the at least one child node is configured to be triggered by the judged result of the positioning module.

4. The robot of claim 1, wherein the operating system further comprises a control module used to control the robot to move.

5. The robot of claim 1, wherein the operating system further comprises a path planning module and a control module; and the path planning module is used to plan a planned path, and the control module is used to control the robot to move along the planned path.

6. The robot of claim 5, wherein a working method of the operating system comprising:
S10, forming a planned path and sending the planned path to the control module by the path planning module;
S11, controlling the robot to move along the planned path by the control module;
S12, sensing whether the robot is in the target area by the positioning module, if yes, go to S13, if no, back to S11; and
S13, executing the behavior tree, to make the robot perform a corresponding action, and back to S10.

7. The robot of claim 5, wherein the action performance module is a plurality of behavior trees, and a working method of the operating system comprising:
S20, forming a planned path according to an initial position of the robot and the target area, and sending the planned path to the control module by the path planning module, wherein the planned path passes through a first target area, a second target area . . . a Nth target area in that order;
S21, controlling the robot to move along the planned path by the control module, and setting n=1;
S22, sensing whether the robot is in a nth target area by the positioning module, if yes, go to S23, if no, back to S21;
S23, executing one of the plurality of behavior trees corresponding to the nth target area, and go to S24;
S24, judging whether n=N, if yes, go to S26, if no, go to S25;
S25, setting n=n+1, and back to S22; and
S26, back to S20.

8. The robot of claim 5, wherein the action performance module is a plurality of behavior trees, and a working method of the operating system comprising:
S30, forming a planned path according to an initial position of the robot and a plurality of target areas, and sending the planned path to the control module by the path planning module, wherein the planned path passes through the plurality of target areas;
S31, controlling the robot to move along the planned path by the control module, and re-planning a path as needed;
S32, sensing whether the robot is in one of the plurality of target areas by the positioning module, if yes, go to S33, if no, back to S31;
S33, executing one of the plurality of behavior trees corresponding to one of the plurality of target areas in which the robot is currently located, and go to S34;
S34, controlling the robot to continue to move along the planned path by the control module, and re-planning the path as needed;
S35, sensing whether the robot is in the rest of the plurality of target areas by the positioning module, if yes, go to S36, if no, back to S34;
S36, executing one of the plurality of behavior trees corresponding to the rest of the plurality of target areas in which the robot is currently located, and go to S37; and
S37, judging whether the robot passes through all the plurality of target areas, if yes, back to S30, if no, back to S34.

9. The robot of claim 1, wherein the operating system further comprises a control module used to control the robot to move.

10. The robot of claim 9, wherein the positioning module is used to position the robot and judge whether the position of the robot is in one of a plurality of target areas, and a working method of the operating system comprising:
S30″, controlling the robot to move randomly between any two of the plurality of target areas by the control module;
S31″, sensing whether the robot is in any one of the plurality of target areas by the positioning module, if yes, go to S32″, if no, back to S30″; and
S32″, executing the behavior tree corresponding to an target area where the robot is currently located, and back to S30″.

11. A robot comprising:
a robot body; and
an operating system comprising:
an action performance module that is at least one behavior tree;
a path planning module used to plan a planned path;
a control module used to control the robot to move along the planned path; and
a positioning module used to position the robot, judge whether a position of the robot is in at least one target area, and transmit a judged result to the action performance module; and the at least one behavior tree is configured to be triggered by the judged result.

12. The robot of claim 11, wherein the at least one behavior tree comprises a plurality of behavior trees, and the at least one target area comprises a plurality of target areas; and the positioning module is used to judge whether the robot is in one of the plurality of target areas, each of the plurality of target areas corresponds to one of the plurality of behavior trees, and each of the plurality of behavior trees is triggered by corresponding judged result.
